(19) United States
(12) Patent Application Publication
(10) Pub. No.: US 2006/0031259 A1
(43) Pub. Date: Feb. 9, 2006

(54) Equipment management method and system for hospitals

(76) Inventors: Joseph A. Gibson, Westminster, CO (US); Anna H. Gibson, Aurora, CO (US)

Correspondence Address: John E. Reilly, 1554 Emerson Street, Denver, CO, 80218, US

(21) Appl. No.: 11/194,325

(22) Filed: Aug. 1, 2005

Related U.S. Application Data
(60) Provisional application No. 60/599,808, filed on Aug. 6, 2004.

(51) Int. Cl. G06F 17/00; G06Q 99/00; G06F 3/00

(52) U.S. Cl. 707/104.1; 705/1; 715/764

(57) ABSTRACT

An asset management system includes a database with a plurality of tables each containing a plurality of fields of information, selected of the fields in one table corresponding to fields in at least one of the other tables with lines of communication so that activation of a selected field in one of the tables will enable activation of a corresponding field in one of the other tables, and each table may contain one or more fields which are linked together with corresponding fields in other tables and permit linking back and forth between fields. In a method of managing assets for a plurality of customers, data is input on a database for identifying each customer including ID number, location and departments of the customer at each location which is augmented by associating a code for each customer and asset entered, inputting data regarding each activity that relates to a work order for each asset and tracking data relating to the work done, further inputting data relating to the purchase and maintenance of each asset and storing all of the data in an organized database.

### CROSS REFERENCES

This application claims the benefit of U.S. Provisional Application Ser. No. 60/399,808, filed 6 Aug., 2004 for EQUIPMENT MANAGEMENT METHOD AND SYSTEM FOR HOSPITALS by Joseph A. Gibson and Anna N. Gibson is hereby incorporated by reference herein in its entirety including original (Copy 1) and identical duplicate (Copy 2) of a compact disk entitled EQUIPMENT MANAGEMENT METHOD AND SYSTEM FOR HOSPITALS containing four files, namely, Apex Biotech Database.mdb, created on Aug. 5, 2004, 42.9 MB; Install Instructions.txt, created on Aug. 6, 2004, 223 B; MouseHook.dll, created on Jul. 28, 2004, 48 K; and Computer Program Listing Appendex.pdf, created on Aug. 6, 2004, 657 KB, accompany this application and are incorporated by reference herein.

### SPECIFICATION

### BACKGROUND

This invention relates to a method and means for maintaining past and current asset information in a business; and more particularly relates to a novel and improved method and means for the most effective tracking of the movement and condition of equipment, furniture, parts and supplies in a business or institution, such as, a hospital and which is capable of scheduling preventive maintenance tasks, maintaining labor records, allocating resources, generating work orders, requisition and purchase in an efficient and highly reliable manner.

### SUMMARY

It is therefore desirable to provide a programmable method and system for tracking and managing a wide diversity of equipment, furniture and materials, herein referred to as assets, for one or more customers as well as for one or more locations and departments for each customer. An asset management system has been devised which is made up of a computer processor, recorder for storing data on a storage medium and a database which is made up of a plurality of tables each containing a plurality of fields of information, selected of the fields in one table corresponding to fields in at least one of the other tables with lines of communication linking together selected fields to one another whereupon activation of a selected field in one of the tables will enable selective activation of a corresponding field in one of the other tables, and each table may contain one or more fields which are linked together with corresponding fields in other tables and permit linking back and forth between fields. In a method of managing assets for a plurality of customers, data is input on a database for identifying each customer including ID number, location and departments of the customer at each location which is augmented by associating a code for each customer and asset entered, inputting data regarding each activity that relates to a work order for each asset and tracking data relating to the work done, further inputting data relating to the purchase and maintenance of each asset and storing all of the data in an organized database for each asset including a code assigned to each asset, customer, vendor and work order as well as tracking the movement and location of each asset between a maintenance center and each customer.

Without limiting the generality of the foregoing, a programmable method and system has been devised which is capable of supporting multiple institutions (customers) and multiple locations and departments for each customer generate labor hours and cost estimates for developing contract proposals; track OEM replacement part costs and alternative suppliers with comparable parts; ability to generate invoices and supporting service documentation; short learning curve necessary to use the system; data can be synchronized whereby data is exchanged between stand-alone systems and networked systems, similar to the synchronization of a PDA with a laptop computer; support multiple concurrent users and multiple customers within one database as well as multiple customer locations, multiple customer departments and multiple customer billing addresses supported within one database whereby assets are assigned a primary billing address which can be temporarily changed as needed for an individual work order; track customer information such as the customer's tax identification number, tax exemption, markup rates on parts, local tax rates based on locality, multiple billing addresses, customer specific fields, departments and building locations; detailed work order information including the customer's billing address, equipment asset number, customer information, comments, parts used and the cost of the parts, travel time, and the invoice number that the work order was billed against; smart service work order templates; ability to update part prices without changing the historical cost of parts; tracks our cost, vendor part number, description, and comments on parts; parts information is independent of all customers; tracks vendor information such as address, ECRI standard nomenclature, account number, telephone and fax numbers; identifies the type of vendor as an equipment manufacturer, original equipment manufacturer (OEM) or as a non-OEM supplier; parts and equipment can be categorized; industry standards, as defined by ECRI, are used to define equipment nomenclature; cross references the ECRI number with ECRI nomenclature; tracks the recommended preventive maintenance (PM) cycles and dates the PM are due; generates proposals based on current customer asset inventories and recommended maintenance times from the categories; selectively flag equipment for coverage under a contract agreement; identifies assets not covered under another contract.

### DEFINITIONS

“APEX ID” references the technician or system manager.

“Asset ID” refers to one or more of the group consisting of equipment, furniture or materials.

“Billing Code” is a code number or term generated for each customer asset, department and location.

“Category ID”—the ECRI number assigned by industry standards to each item of equipment.

“Customer ID” is a code number assigned to each customer (department and location of each customer?).

“Customers” is a business or institution, such as, a hospital.

“PM” refers to preventive maintenance.

“Service Order ID”, a number assigned to each asset or piece of equipment, part, etc. In other words, it is the ID assigned to a particular asset within a service order or work order table.

“Work Order ID” is a code or term assigned to a particular job which may be made up of several items of equipment or parts, each with a different service order so as to identify that piece of equipment and its location.

The above and other objects, advantages and features of the present invention will become more readily appreciated and understood from a consideration of the following detailed description of preferred and modified forms of the present invention when taken together with the accompanying drawings in which:

### BRIEF DESCRIPTION OF DRAWINGS

FIG. 1 is a computer screen display of a Main Switchboard;

FIG. 2 is a screen display of Switchboard-Customers Related Items;

FIG. 3 is a screen display of Customer Select;

FIG. 4 is a screen display of Customers;

FIG. 5 is a screen display of Customer Billing Information;

FIG. 6 is a first screen display of Customer Billing Address Information;

FIG. 7 is a second screen display of Customer Billing Address Information;

FIG. 8 is a screen display of Switchboard-Management Tools;

FIG. 9 is a screen display of Invoicing Select;

FIG. 10 is a screen display of Display Customer;

FIG. 11 is a completed invoice form;

FIG. 12 is a screen display of Non-Contract Bill Rate;

FIG. 13 is a screen display of Equipment Categories;

FIG. 14 is a screen display of Asset Table;

FIG. 15 is a screen display of Vendor Table;

FIG. 16 is a screen display of Proposals;

FIG. 17 is a first screen display of OPEN Service Records;

FIG. 18 is a second screen display of OPEN Service Records;

FIG. 19 is a flow chart of database routines in processing a Work Order; and

FIGS. 20 to 25 are flow charts illustrating the relationships or links between fields as illustrated in the screen displays of FIGS. 1 to 18.

### DETAILED DESCRIPTION

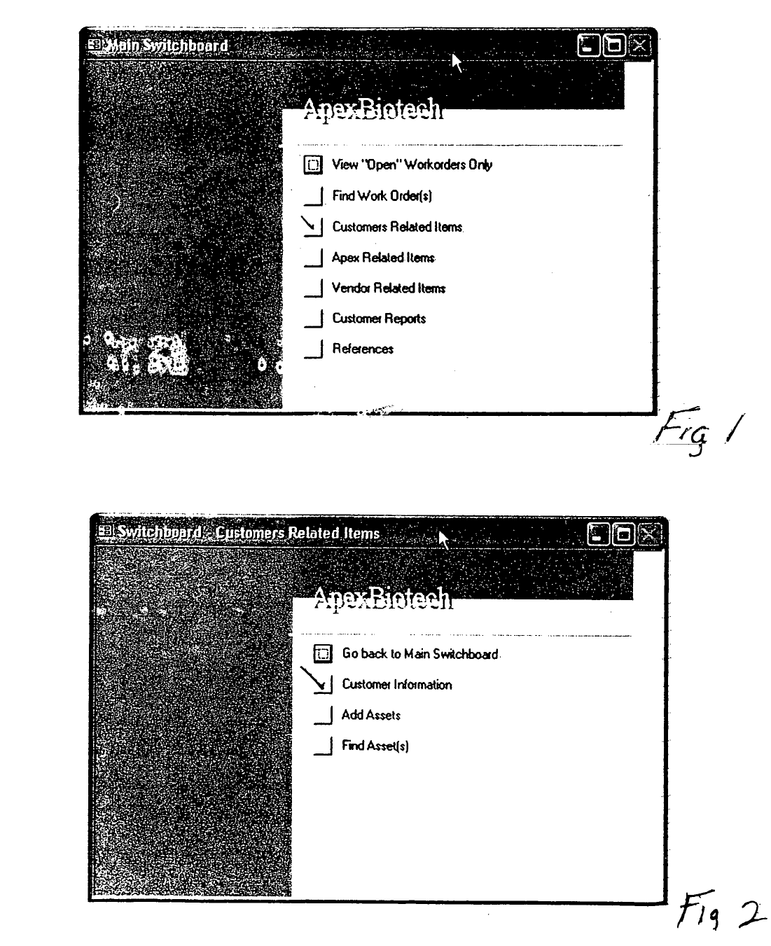

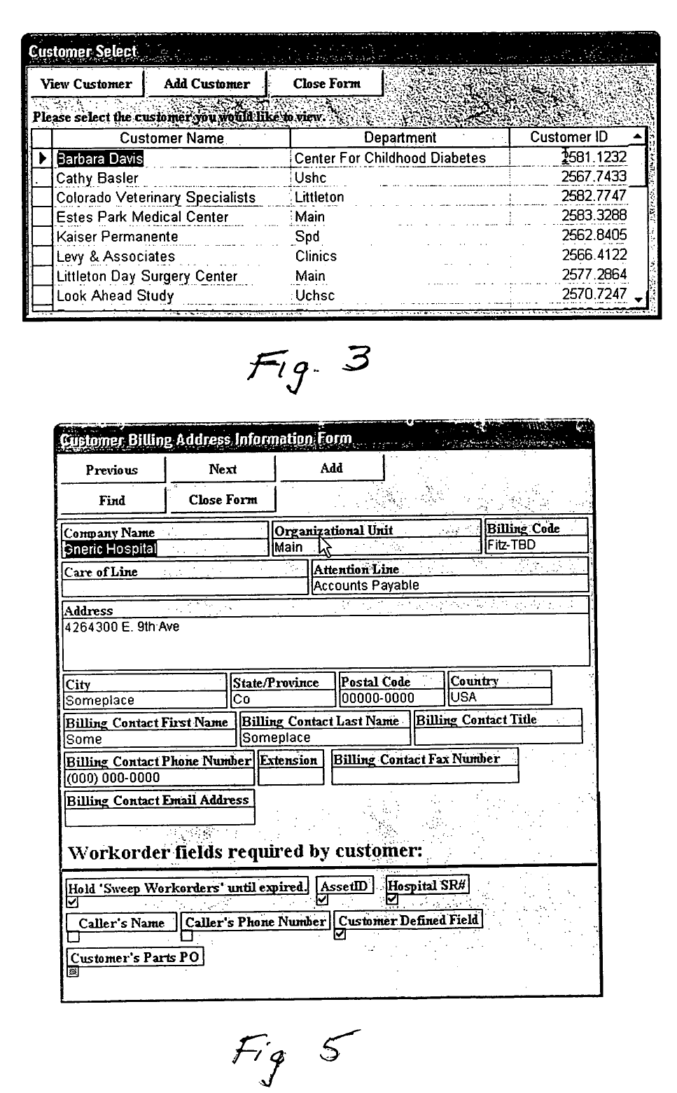

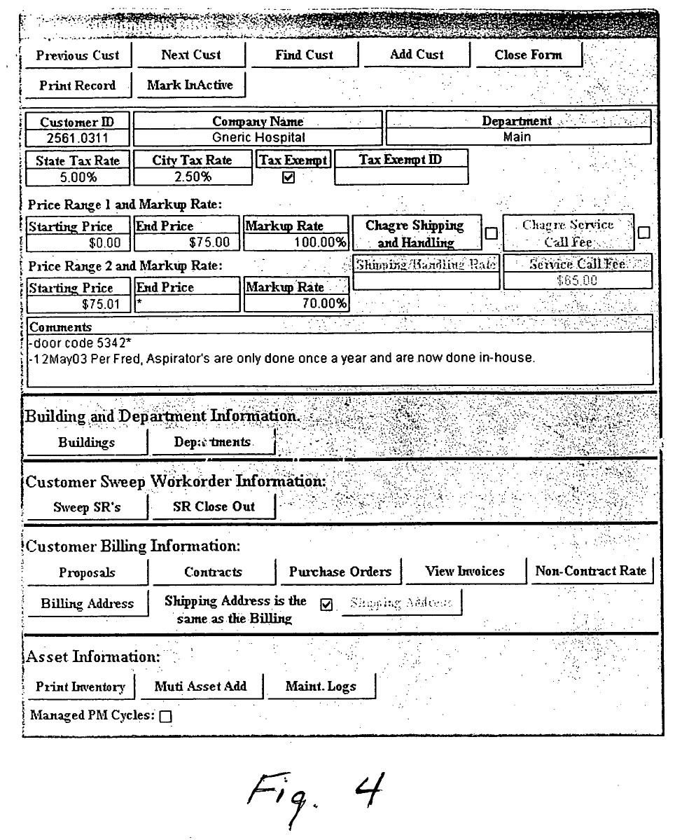

Referring in detail to the drawings, FIGS. 1 to 19 illustrate a number of computer screens for performing a variety of functions in tracking and managing assets. As illustrated in FIG. 1, Main Switchboard enables the user to select a particular customer by clicking on Customers Related Items and which advances to FIG. 2 Switchboard-Customers Related Items. Clicking on Customer Information brings up FIG. 3 Customer Select which identifies the customers or hospitals that subscribe to this program. Each customer has a Customer ID based on a code number as described under Definitions.

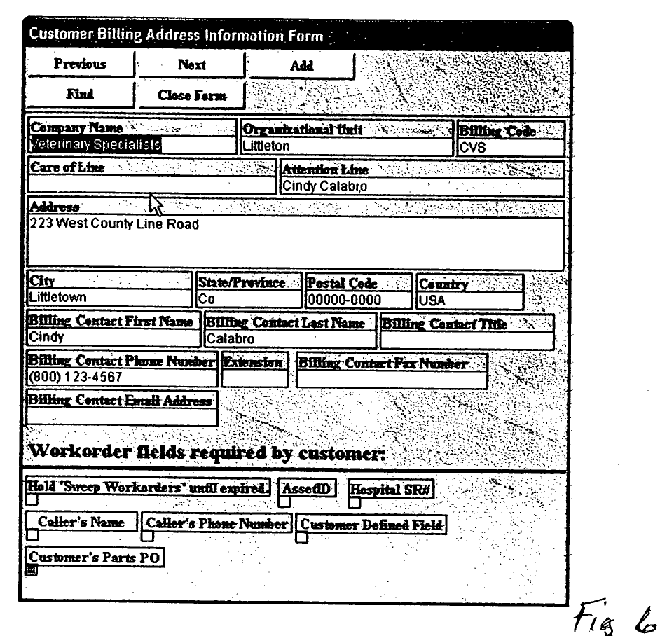

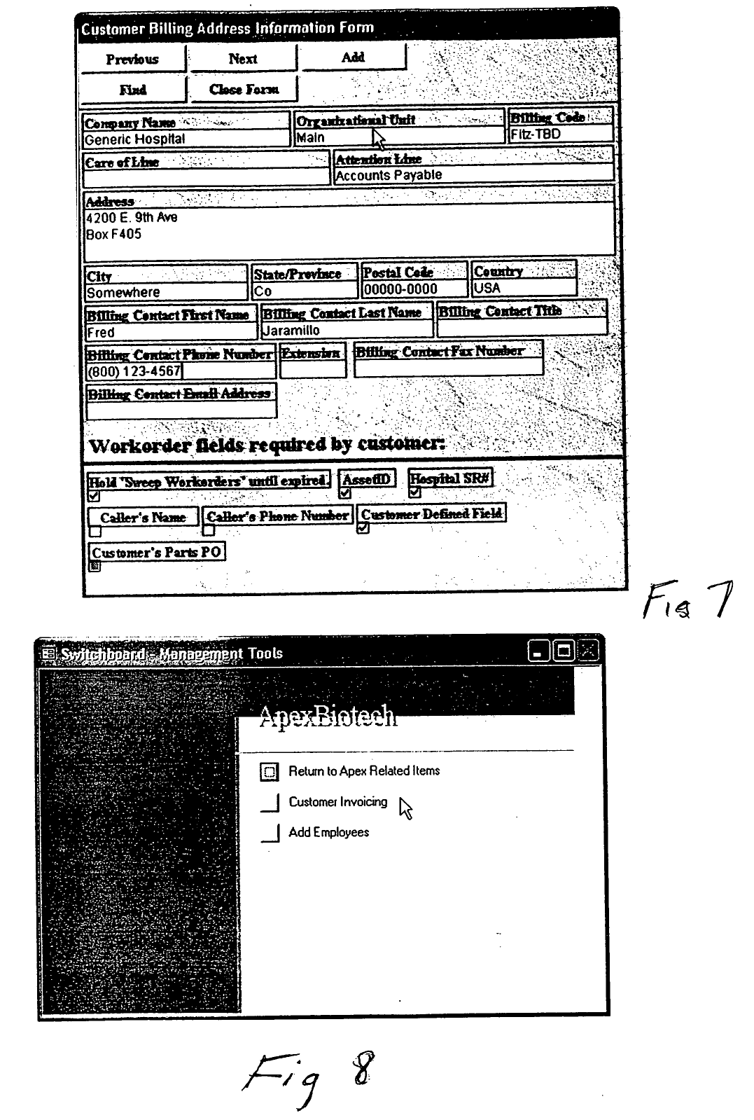

If Generic Hospital is selected, click on inv Customer will bring up FIG. 4 Customers. It is important to note that UV Hospital may have several different locations, and each location will be comprised of a number of different departments, such as, Emergency Room, Heart Center, Surgery, etc. By selecting Departments under Building and Department Information of FIG. 4 will bring up a list of departments at each location under Department Name of the PM Cycles window or screen. Under Department Name, it is possible to scroll down to a particular department at a selected location. Accordingly, the system enables selection of one of several customers, one of multiple locations for each customer, and one of multiple departments at each location. Assets are assigned a primary Billing Address which can be temporarily changed for an individual Work Order. As seen from the Customer screen, it is possible to track information on each customer activity which relates to a Work Order for a piece of equipment, part or material and specifically tracks information, such as, Tax ID, Parts Mark-Up Rate, Tax Rates, Billing Addresses, Customer Required Fields, Departments, Buildings. For example, selecting Billing Address which appears under Customer Billing Information in FIG. 4 will bring up Billing Address screen, FIG. 5.

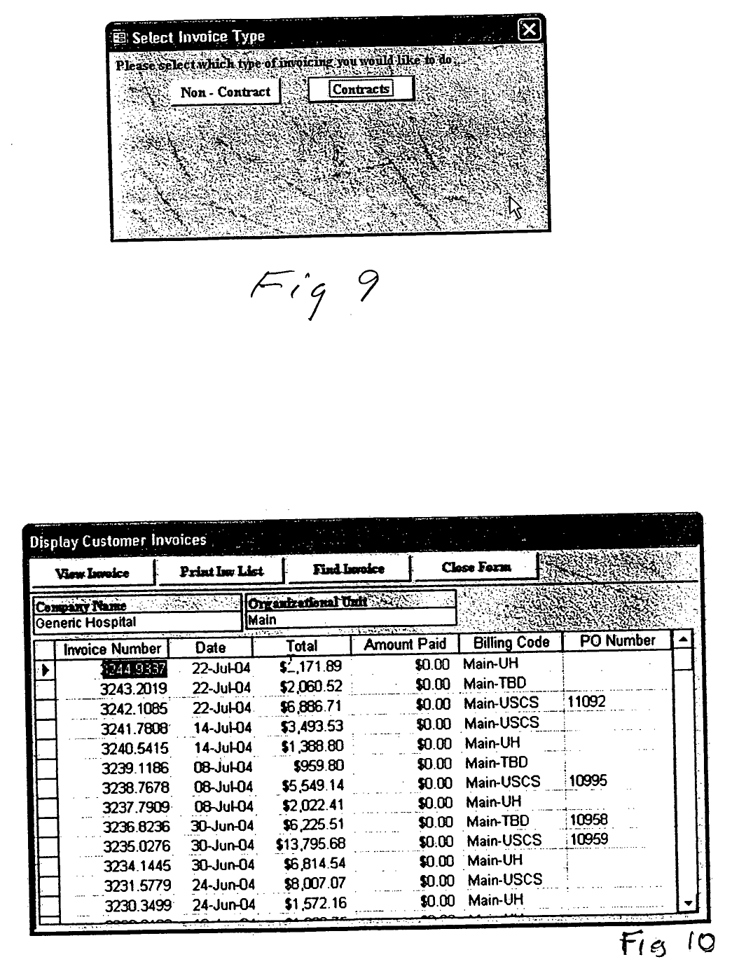

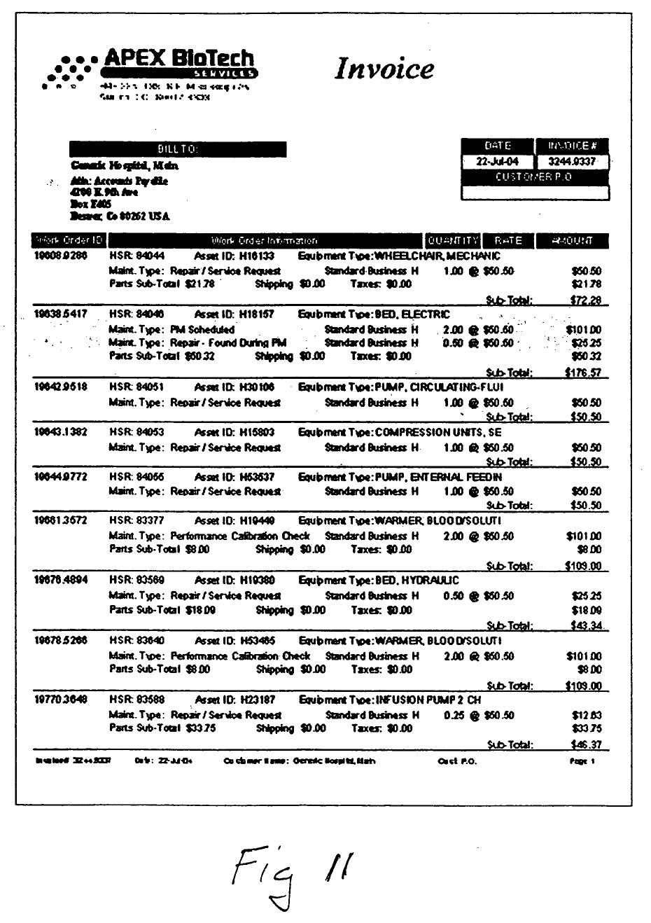

At the upper right of the Customer Billing Address Information screens, FIGS. 6 and 7, there is a field referred to as Billing Code. For each given work order to be hereinafter described, the Billing Code field determines precisely to which customer and location the work order is to be billed. For example, if the work order is for maintenance and requires ordering of parts to repair damaged equipment, it is necessary to determine whether the equipment is still under warranty for the particular repair required. If under warranty, it may then be billed to the primary billing address of the customer; but if not under warranty, it is billed to a particular patient. It may then be necessary to bill the customer at the patient's location so that the patient can be billed along with other hospital or customer charges. This is just one example but it is intended to illustrate that it is possible to override on a case-by-case basis to whom the billing is to be directed.

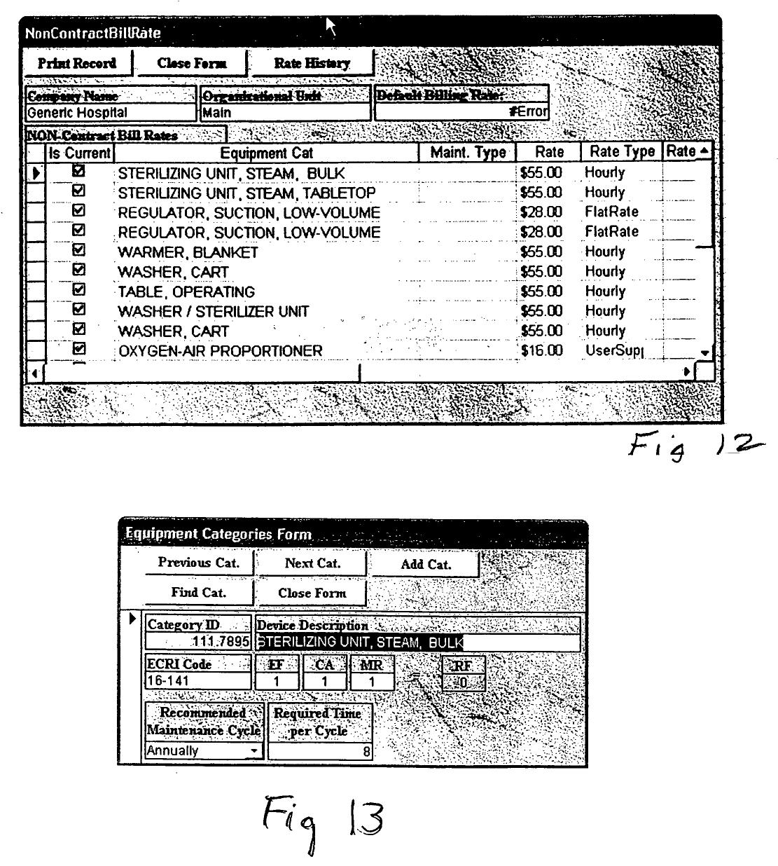

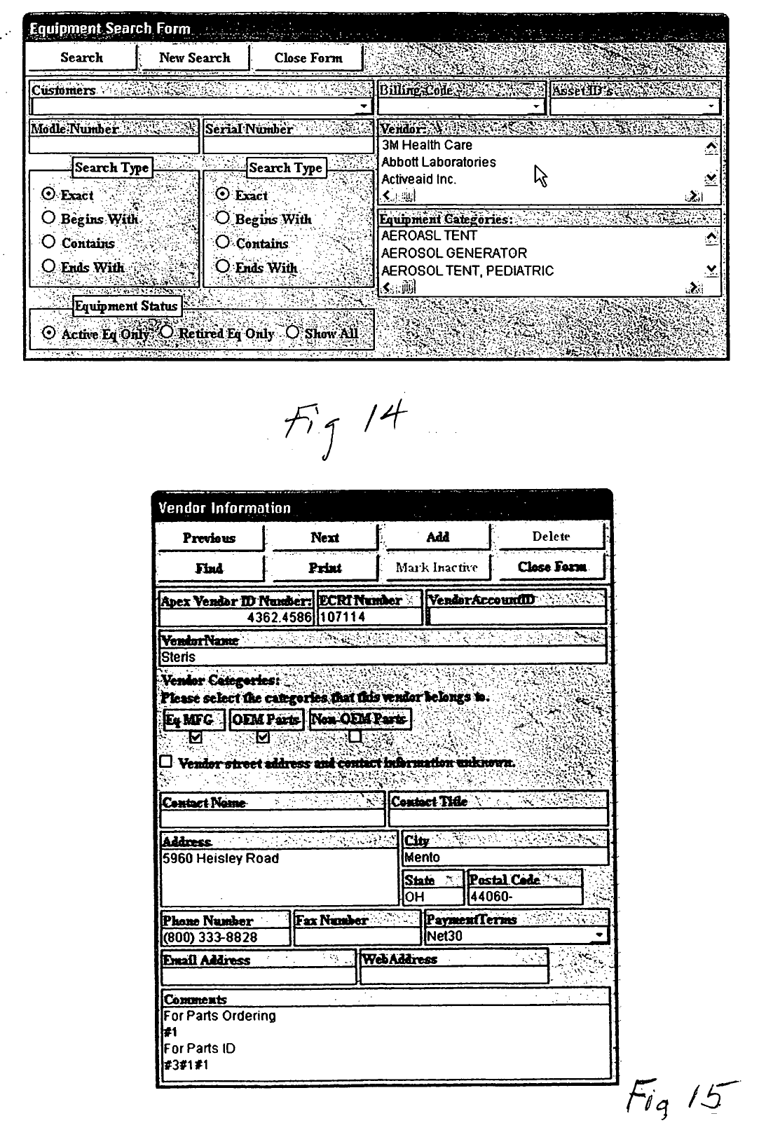

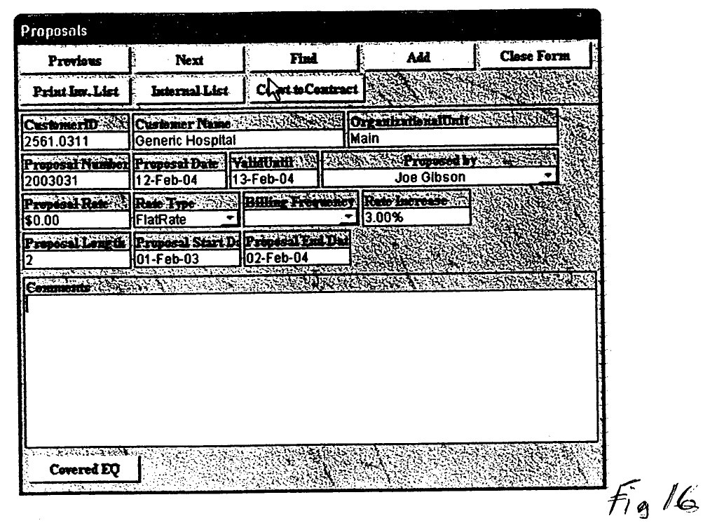

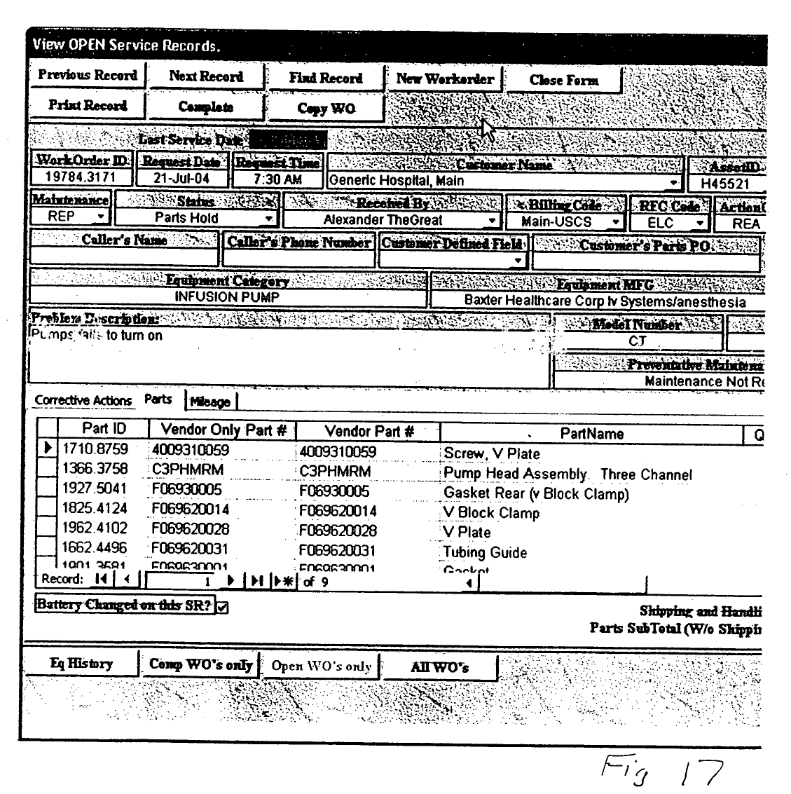

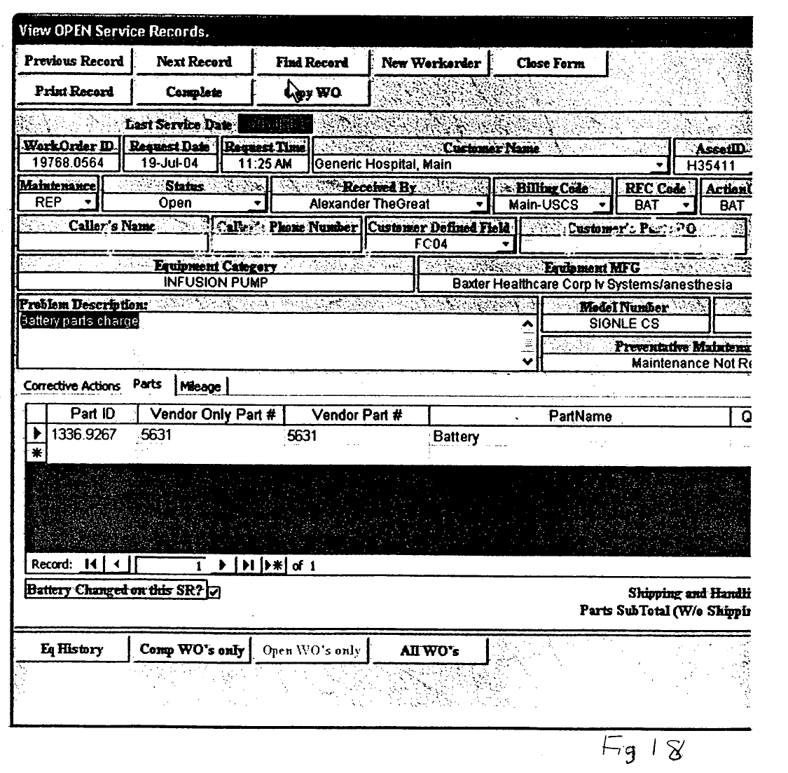

In order to invoice a work order for a particular customer, referring back to Main Switchboard FIG. 1, select Apex Related Items. Management Tools which will open Switchboard—Management Tools FIG. 8; and select Customer Invoicing to bring up Select Invoice Type FIG. 9. In the absence of a contract or agreement with the customer, a rate schedule is provided as illustrated in the Non-Contract Bill Rate screen FIG. 12 that establishes the hourly or flat rate for maintenance of each piece of equipment and for each customer; i.e., it may be a default rate established for that customer or a generic rate that is common to certain pieces of equipment for all customers. Select Non-Contract to bring up a list of items which have been completed and are ready for invoicing under the Display Customer FIG. 10. By clicking on Customer Select FIG. 3 will bring up only those items that are ready to be invoiced to that particular customer. Return to Main Switchboard FIG. 1, select “Customer Information”, and select a customer from the list of Customers FIG. 4. Click on View Customer under Customer Billing Information to bring up from Customer Inv list of invoices; click View Invoice which will produce the specific invoice number selected under INV View. The Invoice FIG. 11 identifies the Work Order ID, Work Order Information, such as, the nature or type of maintenance, parts subtotal, equipment type, shipping, taxes, quantity and rate. Whether or not the equipment is under warranty is also reflected. If the customer desires to see any further detail, a copy of the work order may be furnished for each item which includes any comments relative to parts, repair or maintenance. Further, the Invoice FIG. 11 reflects whether labor performed on the particular piece of equipment was for “repair” or for “PM” (preventive maintenance).

In certain situations, where no work order is received but it becomes necessary to service certain pieces of equipment, that service or maintenance is performed under a “Sweep Work Order” which is a number assigned by the maintenance personnel. Sometimes the customer will issue a work order from its system to APEX and it is what is called a “sweep work order” so it's a blanket generic work order, e.g. “PM on beds”. APEX then looks for beds that have to have maintenance, do the work and assign that work to that sweep work order. Then they close out their work order but the customer work order remains open and can be applied to multiple work orders so if they find ten beds that need to be serviced they go on ten separate work orders on the APEX database but for the customer they all go on one work order.

APEX has the ability to operate on a one-to-one relationship where for every piece of equipment worked on, one work order is assigned and receives one work order ID from the customer's database. The system has the ability of tracking one-to-many jobs where for every piece of equipment work done there is assigned one work order but can assign multiple work orders to one copy of a customer's work order. There is also the ability to assign two or more pieces of equipment to one of the APEX work orders but is then assigned to two or more other customer work orders. Accordingly, even though all of the information is for one customer, there is a Sweep Work Order for that customer meaning that the customer wanted it billed on a regular basis, such as, once a month for that billing code. Again, if there are two or more items assigned to a Sweep Work Order, all two or more items are held until the end of the month and are invoiced at once. The next customer on the other hand may issue a Sweep Work Order from the same system but ask that it be invoiced weekly.

Referring to Customers screen FIG. 4, click on Billing Address FIG. 5 to bring up Work Order fields Required by Customer at the bottom of the screen. The first field is Hold Sweep Orders Until Expired so that there is a beginning date and expiration date on the Sweep Work Orders which permits APEX to perform the work and invoice at the end of that period. Thus by going to the Invoice Form FIG. 11 and select Billing Code it will automatically filter out all work orders based upon this information. It will be noted that other fields may be checked under Work Order fields.

Referring to the main switchboard FIG. 1, select APEX Related Items followed by Display Contracts Invoicing Select, FIG. 11; and under Customer Billing Information are able to bring up Current Customer Contracts, not shown. Here, the database has the ability to track different billing codes for each customer, and each customer either may be on a Non-Contract or Contract rate (see FIG. 9). Thus, if a customer requests that certain items be covered under a contract, a rate is quoted on that contract which covers preventive maintenance for a piece of equipment. On the other hand, a repair to that item of equipment may be Non-Contract and invoiced at the non-contract rate.

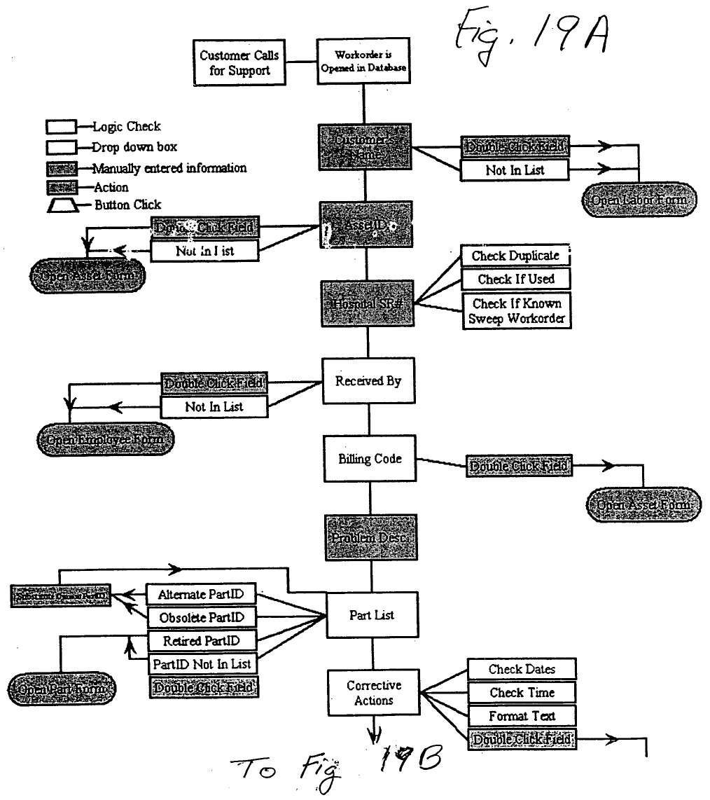

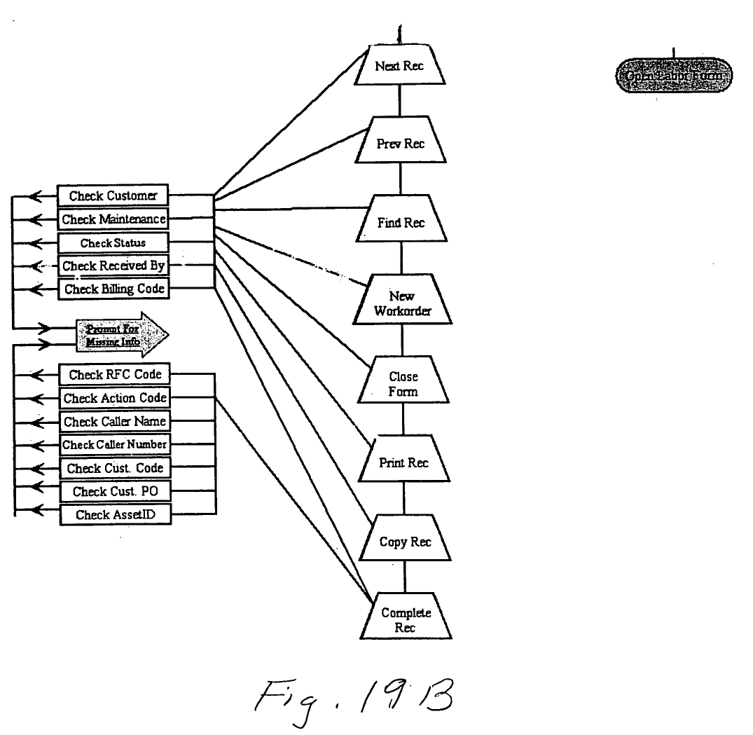

At the Main Switchboard FIG. 1, in order to obtain or review information relating to assets, or equipment, click on Customer Related Items, Find Assets, which brings up the Equipment Table, also referred to as Equipment Search Form FIG. 14. In FIG. 14, it is possible to track “Equipment Categories”, and “Vendor” for each item of equipment as well as serial number, model, make. Clicking on Search produces the building/department location, warranty information, total part installed, total cost of ownership, etc. Again referring back to the Asset Search Form FIG. 14, other information can be retrieved with respect to search type and equipment status as illustrated. Most essential to a description of asset information, or equipment categories, is to employ official or standard nomenclature for each item. For example, “wheelchair”, “handicapped wheelchair”, “powered wheelchair”. Thus, if a wheelchair is ordered that was not in the system before but need to start tracking it, it is important to select the equipment category, scroll to the type of wheelchair and employ that identification. In this way, the technician is able to track each piece of equipment that is entered into the system; and under the equipment categories table of FIG. 13 it is possible to track ECRI descriptions and numbers as well as recommended maintenance cycles and times under each asset or device description.

In addition, the database automatically lists each item of equipment on a work order with appropriate asset ID or code number. Thus, when it does the invoicing it will print out with the invoice and the work order so that, when the customer gets the information, it can verify each item of equipment listed.

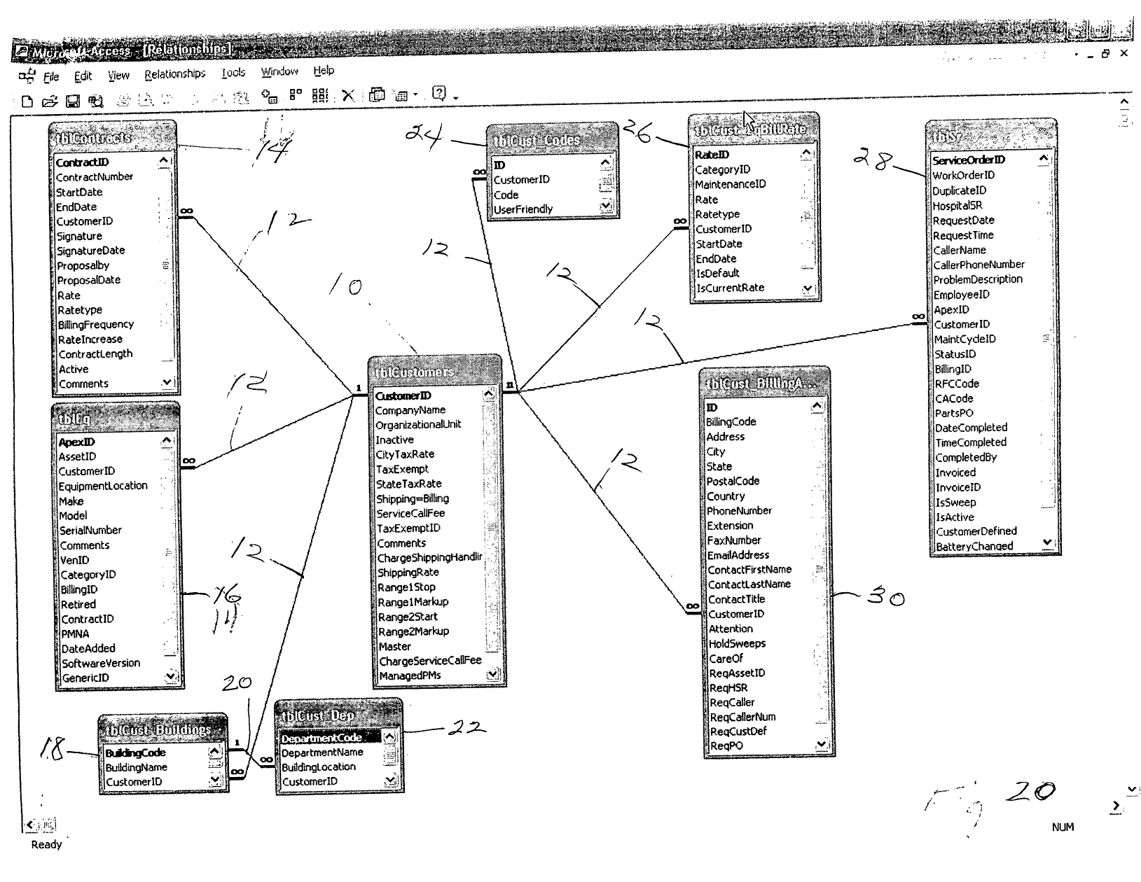

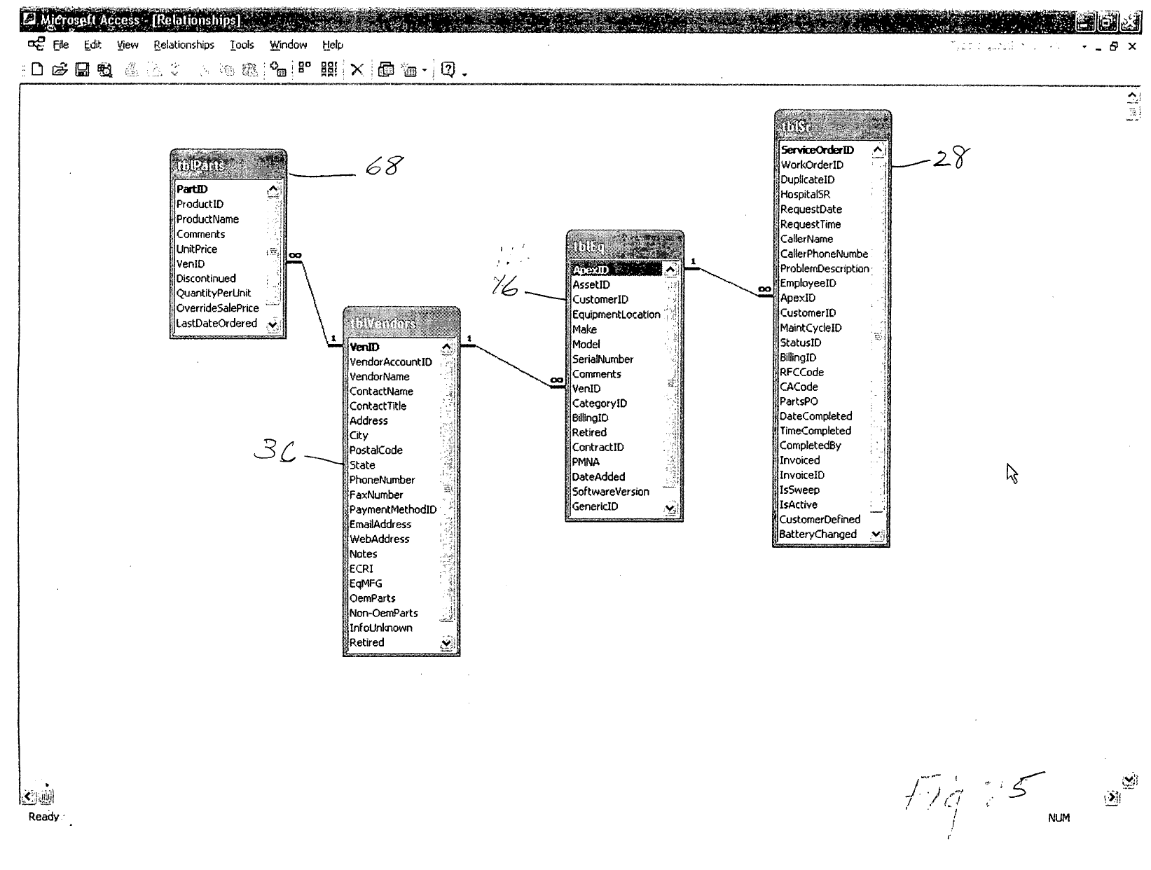

When each piece of equipment is entered into the computer, the technician must ascertain from the Vendor Table FIG. 15 the vendor which is entered into the computer at the same time. Then when the technician goes to select the category type will manually select “wheelchair” or other piece of equipment. Similarly, the asset ID must be taken from the piece of equipment and entered at which point the database automatically links the information into each appropriate table as more fully explained with reference to FIGS. 20 to 25.

The database stores other information that is independent of customers. For example, the Parts screen as well as the Asset Information screen tracks all relevant information concerning cost, vendor ID, description. Further, in the case of Asset Information, may include further information relative to warranty, original cost of equipment, expected life span and appreciation.

A special category is provided for equipment in which the nomenclature has been standardized and is listed under Equipment Categories FIG. 13 and is commonly referred to as ECRI. The categories listed include ECRI descriptions, ECRI numbers and tracks recommended maintenance cycles and times.

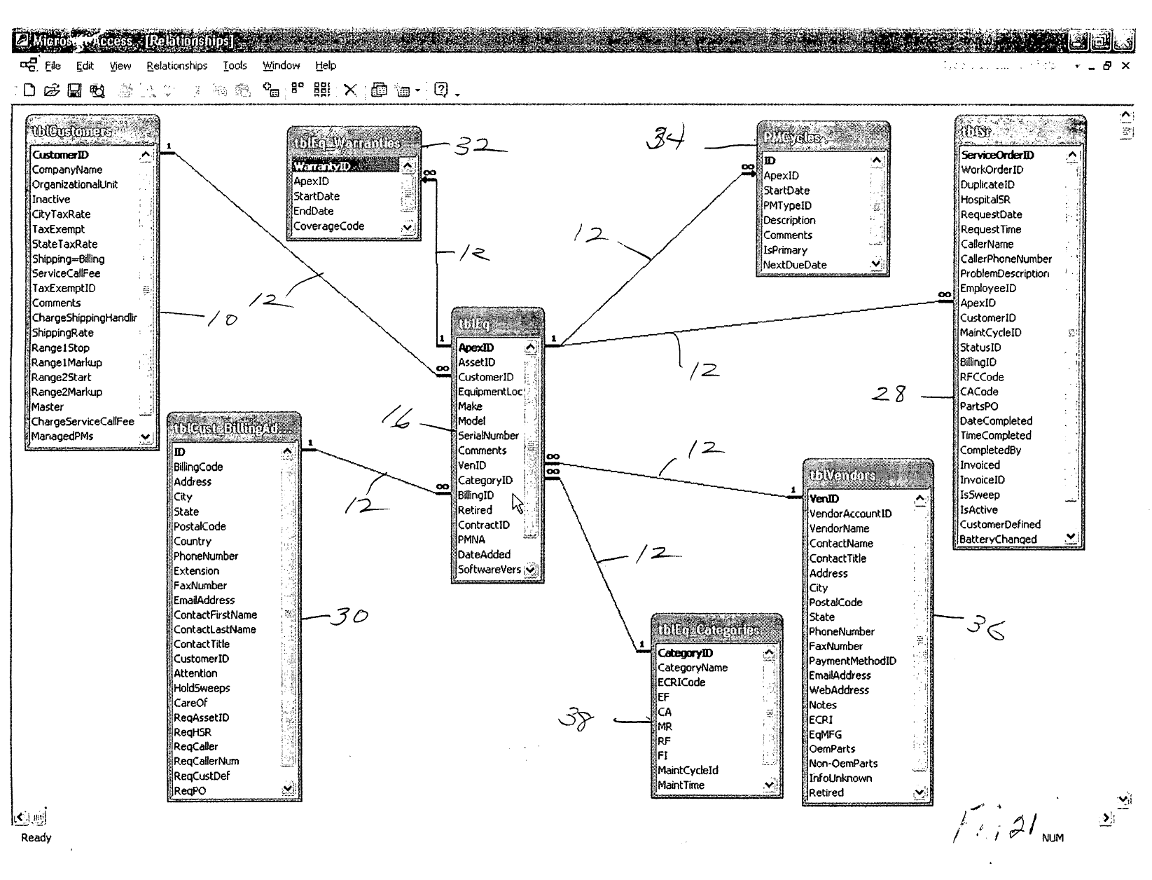

In certain situations where a customer requests a bid or proposal from the technician, for example, to provide a preventive maintenance contract for certain equipment, such as, wheelchairs: The technician would prepare a Proposal FIG. 16 which would indicate that the wheelchairs have to be serviced once a year and require a certain time, such as, an hour to service each wheelchair. That information would be entered along with the serial number, model number and other items as indicated in FIG. 16. Thus, the proposal permits entry of suggested maintenance frequency, such as, once a year, twice a year, etc.; how long it takes to service, such as, half an hour. The database will automatically locate the equipment category of wheelchair and determine the total maintenance time and cost for the entire proposal. For example, this avoids the necessity of preparing a proposal for each item of equipment to be serviced over a lengthy period of time and especially where there are several items of equipment in the same category to be serviced.

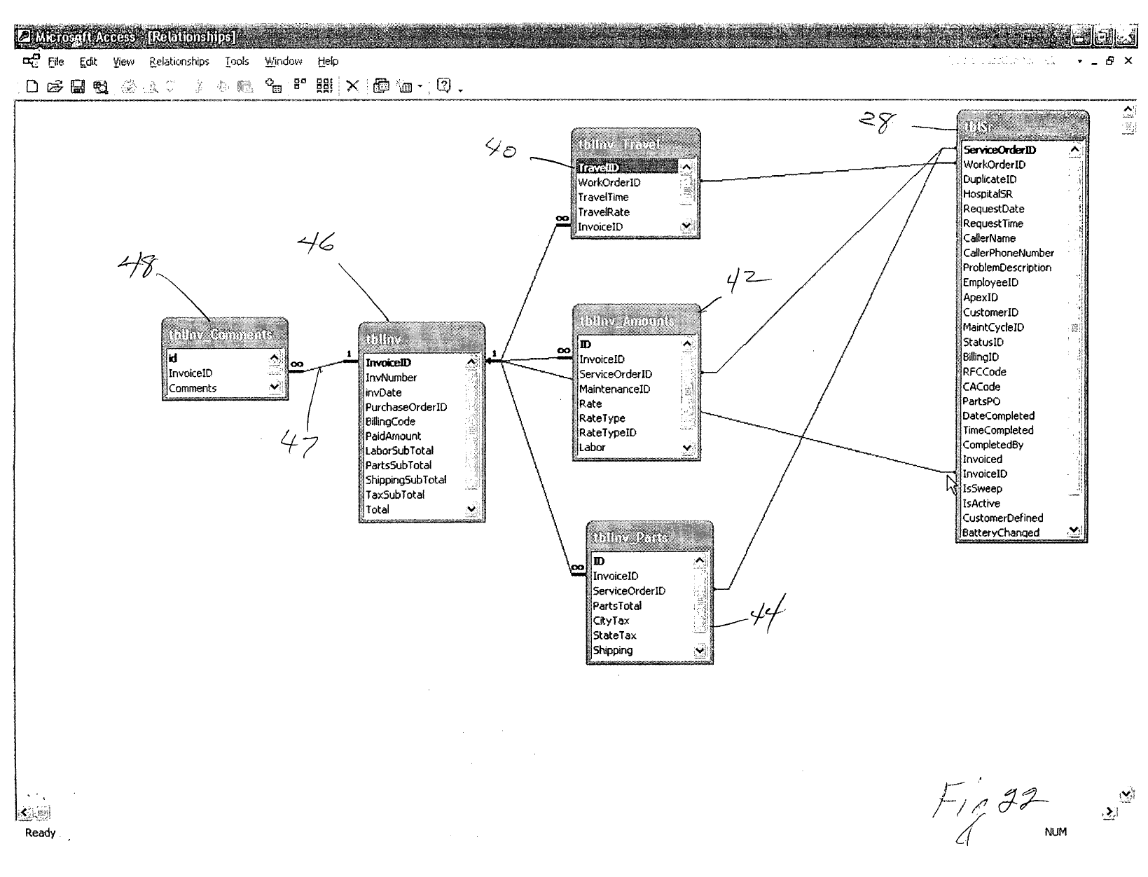

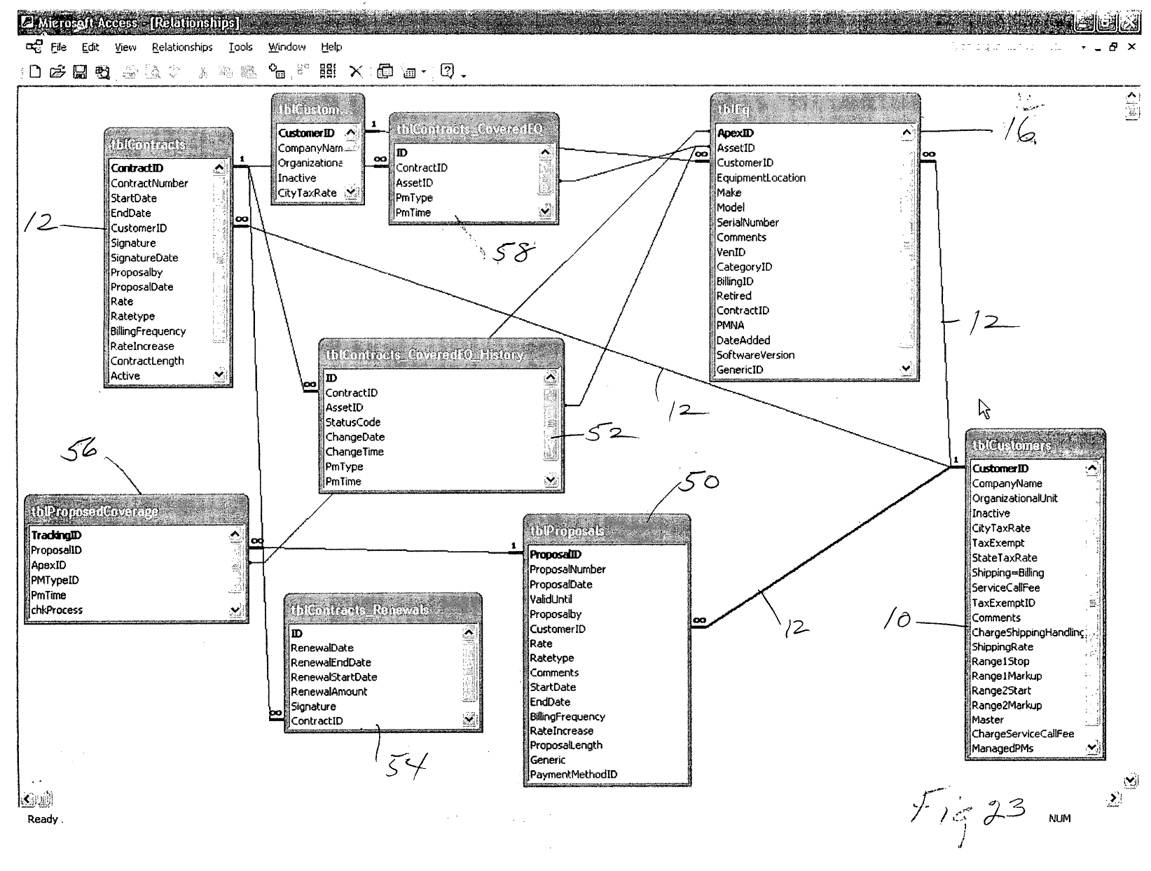

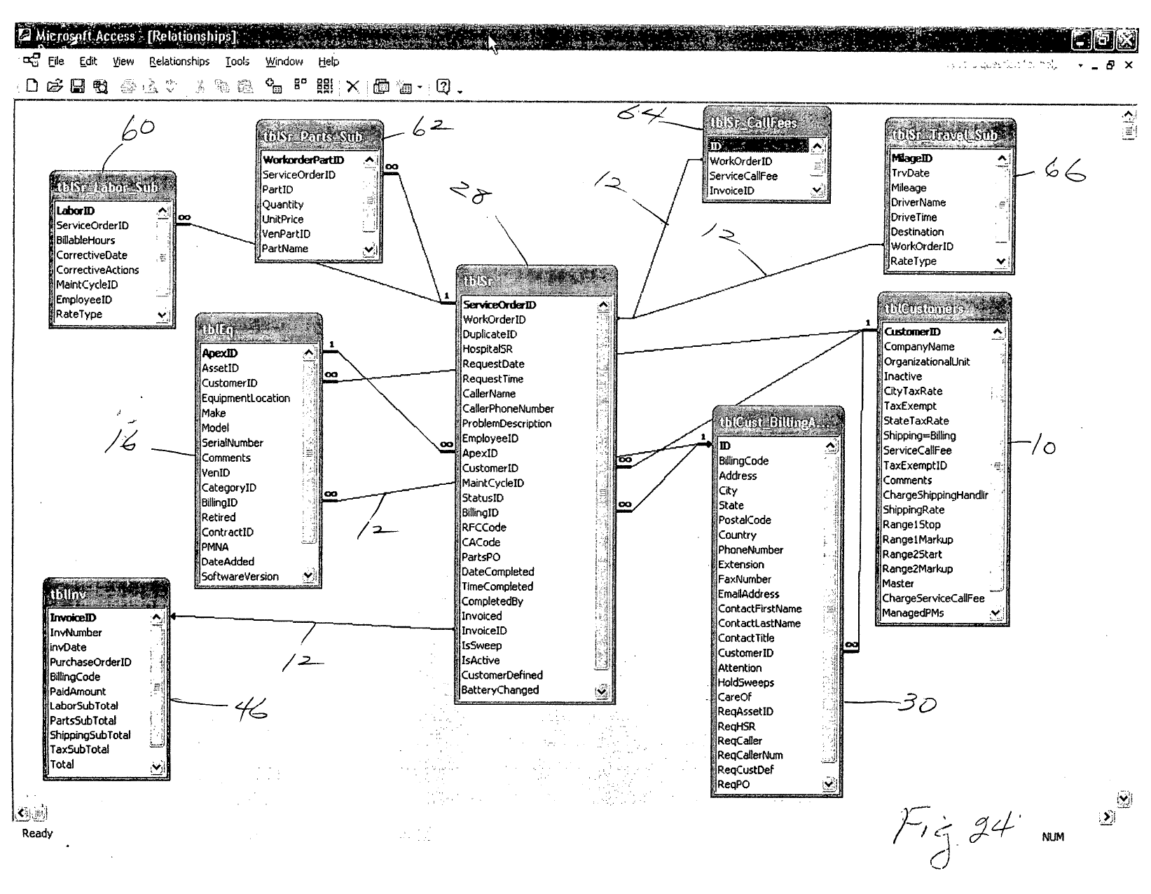

Any preventive maintenance to be performed is itemized under a tracking table, not shown, which is linked to Proposals FIG. 16. FIGS. 17 and 18 illustrate OPEN Service Record forms which can be brought up from the main switchboard FIG. 1 under View Open Work Orders Only. FIGS. 19A and 19B illustrate the routines that the database follows in processing a Work Order.

FIGS. 20 to 25 illustrate the relationships between the various Tables as illustrated in the hereinbefore referred to screen displays of FIGS. 1 to 19 as well as other Tables. For example, the Customers table 10 basically corresponds to the information illustrated in FIG. 4, and the connecting links or lines 12 represent the lines of communication between the Customer table 10 and other tables, such as, Contracts table 16, Equipment table 14, and Customer Buildings table 18. The table 18 has its own link 20 to the Departments table 22.

Another set of communicating lines or links 12 extend between the customer table 10 and Customer Codes table 24, Customer Billing rate table 26, Service Record table 28 and Billing Address table 30.

For example, if a technician is in one of the fields of the Equipment table 16 and wanted to know if a contract covered a particular transaction, the technician would click on Customer ID in the table 16 to link to the Customer table 10 and then advance to the same Customer ID in the contracts table 14 to advance through the various fields in that table.

FIGS. 22 to 24 illustrate the manner in which certain tables may be linked to different combinations of tables than illustrated in FIG. 20. For example, in FIG. 21, the Equipment table 14 is linked to the Customer table 10, Service Order table 28 and Billing Address table 30 along with separate links 12 to Warranties table 32, Preventive Maintenance table 34, Vendor's table 36 and Equipment Categories table 38. Again, as illustrated in FIG. 5, if a technician is in the Customer table 10 and wishes to know the name of a vendor for a particular piece of equipment associated with a customer, the technician would bring up the Equipment table 14, click on Vendor ID to bring up the table 36. In table 36, the technician can scroll down to the piece of equipment in question and from that determine the vendor name for that piece of equipment.

The versatility of the system is further illustrated by the links between the Service Order table 28 and the Equipment table 16 as shown in FIG. 21, and Invoice Travel table 40, Invoice Amounts table 42 and Invoice Parts table 44, these three tables in turn being linked to the main Invoice table 46 which has a separate link 47 to Invoice Comments table or field 48.

FIG. 23 illustrates the link up between the Customers table 10, Equipment table 16 and numerous Contracts-related tables including Proposals 50, History 52, Renewals 54, Coverage 56 and 58. Thus, a link may be established between the Proposals table 50 via Customer table 10 to the Contracts table 12.

FIG. 24 illustrates the importance of the Service Record table which is linked to a number of the primary tables including Customers 10, Equipment 16, Billing Address 30 and Invoices 46; and also it has direct links to secondary tables for Labor 60, Parts 62, Service Call Fees 64 and Travel 66.

The Service Record table 28 is important from the standpoint that it codes each piece of equipment and part with a different code number in order to facilitate tracking of each specific item. For example, a quantity of hospital beds may be purchased and collectively assigned one number. However, one or more of the beds may be transferred to different locations for different customers as well as patients and therefore requires a unique number to identify each bed. When the technician opens up a work order, the first thing that is displayed is a customer name and, when a customer is selected, the drop-down menu will display only that equipment owned by the customer selected; the rest of the equipment is filtered out by the database and does not appear. This is made possible by assigning of a unique number or service order number to each item of equipment of each customer at a particular location. Also, the asset ID will follow along with each customer name, for example, in processing a work order.

FIG. 25 is somewhat of an extension of FIG. 24 and illustrates the connection of the Parts table 68 and Vendor's table 36 via the Equipment table 16 to the Service Record table 28. Stated another way, the service order number is a unique number assigned to a particular piece of equipment or part within the Work Order table; customer ID is a unique number assigned to each customer within the Customer table; APEX ID is a number assigned to the technician within the Equipment table as well as the Service Order table.

Each of the codes or ID numbers is generated by the database in response to the entry of information within a specific field by the technician. For example, referring to FIG. 3, when the technician selects Generic Hospital at the Main location, that information will be highlighted in FIG. 4. That information then appears with a gray background and is automatically generated by the database; and the other information that is typed into specific boxes or fields is that which was generated or typed in by the technician.

By way of illustration but not limitation, the database operates through the tables to carry out the following principal functions:

A. Customers
1. Can track more than one location.
2. Can track more than one department or location.
3. Track more than one billing address per customer across locations and departments.
4. Assets are assigned a primary billing address which can be temporarily changed for an individual work order.
5. Tracks information on customers, such as, tax ID, parts mark-up rate, tax rates, billing addresses, customer required fields, departments, buildings.

B. Work Orders:
1. Tracks the information related to the work order and customer, i.e., billing address, asset ID, customer information, comments, parts travel, and invoice information.
2. Related to both customer and asset.
3. Information entered in work order is independent of changes made after entering of information, i.e., part price and description remains unchanged even if the main parts table is updated with new price and description.

C. Parts
1. Tracks APEX cost, vendor part ID, description, and comments on parts.
2. Information in this table is independent of all customers, i.e., the cost listed here is applied to all customers with APEX mark-up.

D. Vendors
1. Tracks vendor information such as Address, ECRI number, account number, phone/fax.
2. Track vendor types—EQ MFG, OEM Parts, Non-OEM parts.

E. Equipment Categories
1. Tracks ECRI Descriptions.
2. Tracks ECRI Numbers.
3. Tracks recommended maintenance cycles and times.

F. Contracts (Proposals)
1. Generates proposals based on current customer asset inventories and recommended maintenance times from the categories.
2. Covered items are selectable.
3. Time and frequency can be changed manually.
4. Verifies assets are not currently covered by another contract.

G. Purchasing
1. Tracks what was ordered and when.
2. Automatic update of parts table with pricing.
3. Tracks quantity and location of equipment.

H. Asset Information
1. Tracks Vendor, serial number, model, make, building/department locations, warranty information, total part installed, total cost of ownership, date entered in system, owner information, software information, battery history.
2. Original cost of equipment.
3. Expected life span.
4. Depreciation.

I. PM Procedures
1. Tracks recommended procedures for equipment categories/MFG/model.

J. General
1. Can have more than one independent copy that can be synchronized.
2. Multi-user capable.

It is therefore to be understood from the foregoing that while one illustrative embodiment has been set forth in detail the method and system described are readily conformable for innumerable different applications dealing with the purchase and maintenance of assets, such as, for example, equipment, furniture and materials, and that various modifications and changes may be made therein.

We claim:

1. An asset management system comprising:
a database comprising a plurality of tables, each of said tables comprising a plurality of fields of information, selected of said fields in each of said tables corresponding to fields in at least one of said other tables, means linking said selected fields to one another whereupon activation of a selected field in one of said tables will enable selective activation of a corresponding field which is present in one of said other tables.

2. The asset management system according to claim 1 wherein activation of said corresponding field enables display of the categories of information in said one of said tables.

3. The asset management system according to claim 2 wherein said categories of information are listed in a drop-down menu.

4. The asset management system according to claim 3 wherein means are provided for entering the information in each said drop-down menu.

5. The asset management system according to claim 4 wherein said database includes means for revising the information entered in each of said drop-down menus.

6. The asset management system according to claim 1 wherein said database includes separate customer and billing tables, said customer table containing customer information fields including ID number for each customer, location for each customer and departments at each location, said linking means interconnecting a customer ID field in each of said customer and billing tables.

7. The asset management system according to claim 1 wherein said database includes a work order table that stores information on each activity that relates to a work order including code number for each asset, means for tracking information on each customer activity relating to said work order, said linking means for interconnecting a customer ID field in said customer table with a customer ID field in said work order table.

8. The asset management system according to claim 1 wherein said database includes an invoice table that stores information relating to the purchase and maintenance of each said asset including said asset code number.

9. The asset management system according to claim 1 wherein said database includes a vendor table that stores vendor information on each asset owned by each said customer and assigns an asset ID number to each said asset, said vendor table including means for tracking the movement of each said asset.

10. The system according to claim 1 wherein said database includes a contract table for developing contract proposals.

11. The system according to claim 10 wherein said contract table generates information relating to labor costs and cost estimates and verifies that assets are not currently covered by another contract.

12. The system according to claim 7 wherein said work order table includes means to track asset replacement part costs and alternative suppliers with comparable parts.

13. The system according to claim 1 including means for exchanging data between stand-alone systems and networked systems.

14. The system according to claim 6 wherein said customer database includes means for tracking customer tax information and work order information including customer billing address and invoice number that work order was billed against.

15. The system according to claim 14 wherein said customer table includes means for over-riding a billing address from a customer to a patient.

16. The system according to claim 1 wherein said invoice table includes means for differentiating between the maintenance of contract and non-contract assets and the billing rate applicable thereto.

17. The system according to claim 9 wherein said invoice table includes means for identifying whether labor performed on maintenance of a particular asset was for repair or preventive maintenance.

18. The system according to claim 17 wherein said invoice table includes means for performing maintenance under multiple work orders.

19. The system according to claim 1 wherein said database includes a service record table that stores an ID number for each of said assets of each said customer at a particular location.

20. A data processing system for managing assets for a plurality of institutions comprising:
a maintenance center;
computer processor means for processing data;
a recorder for storing data on a storage medium;
means for processing data for identifying each said institution including ID number, location and departments of said institution at each location;
work order information means for processing information regarding each activity that relates to a work order for each piece of said equipment including means for tracking information relating to work done on each asset including tax ID, parts mark-up rate, tax rates, billing addresses;
invoicing means for processing information relating to the purchase and maintenance of each said asset; and
means for storing vendor information on each said asset including an asset ID number assigned to each said asset and means for tracking the movement and location of each said asset between said maintenance center and said institution.

21. The data processing system according to claim 20 wherein said database includes means for developing contract proposals.

22. The data processing system according to claim 21 wherein said last-named means is operative to generate information relating to labor costs and cost estimates and verifies that assets are not currently covered by another contract.

23. The data processing system according to claim 20 wherein said database includes means for storing customer information including ID number for each customer, location of each customer and departments at each location, and multiple screen displays for selectively displaying data and for manually inputting and revising said data stored in said database.

24. The data processing system according to claim 20 wherein said database includes means for storing an ID number for each of said assets of each said customer at a particular location.

25. The data processing system according to claim 20 wherein said database includes means for storing vendor information on each asset stored in said database and for assigning an asset ID number to each said asset.

26. In a data processing system, a method for managing assets for a plurality of customers comprising the steps of:
providing a maintenance center;
providing a computer processor for processing data and inputting data for identifying each said customer including ID number, location and departments of said customer at each location and augmented by associating a code for each said asset;
inputting data regarding each activity that relates to a work order for each said asset and tracking data relating to work done on each said asset including tax ID, parts mark-up rate, tax rates, billing addresses;
inputting data relating to the purchase and maintenance of each said asset; and
storing all of said data in an organized database for each said asset including the code assigned to each said asset and tracking the movement and location of each said asset between said maintenance center and said customer.

27. The method according to claim 26 including the step of assigning a first ID number to each said customer and consecutive ID numbers to each said asset, work order, billing and invoice for each said asset relating to said customer.

28. The method according to claim 26 including the step of organizing said database into tables comprising a plurality of fields of information, said tables including a customer Table, work order table, invoice table, vendor table and a contract table.

29. The method according to claim 28 including the step of linking together selected fields in a plurality of said tables whereby activation of a selected field in one of said tables will automatically link to a corresponding field which is present in other of said tables.

30. The method according to claim 29 wherein activation of a corresponding field which is present in other of said tables is operative to display the categories of information relating to said selected table.

31. The method according to claim 30 wherein said categories of information are listed in multiple screen displays.

32. The method according to claim 31 including the step of manually entering the information in each said multiple screen display.
